(19) United States
(12) Patent Application Publication
(10) Pub. No.: US 2021/0178664 A1
(43) Pub. Date: Jun. 17, 2021

(54) THREE-DIMENSIONAL PRINTER WITH THERMAL FUSION

(71) Applicant: HEWLETT-PACKARD DEVELOPMENT COMPANY, L.P., Spring, TX (US)

(72) Inventors: Wesley R. SCHALK, Vancouver, WA (US); Kris M. ENGLISH, Vancouver, WA (US); Justin M. ROMAN, Vancouver, WA (US); Kevin E. SWIER, Corvallis, OR (US)

(73) Assignee: HEWLETT-PACKARD DEVELOPMENT COMPANY, L.P., Houston, TX (US)

(21) Appl. No.: 16/077,749

(22) PCT Filed: Jul. 28, 2017
(86) PCT No.: PCT/US2017/044345

§ 371 Date: Aug. 14, 2018

(51) Int. Cl. B29C 64/153; B29C 64/329; B29C 64/165; B29C 64/357

(52) U.S. Cl. CPC B29C 64/153; B29C 64/329; B33Y 10/00; B29C 64/357; B29C 64/165

(57) ABSTRACT

A 3D printer and method include a build platform for thermal fusion. The 3D printer also includes a cartridge receiver to hold a material cartridge that accepts build material into the material cartridge from the 3D printer and makes build material available from the material cartridge for printing.

### BACKGROUND

Three-dimensional (3D) printing may produce a 3D object. In particular, a 3D printer may add successive layers of build material, such as powder, to a build platform. The 3D printer may selectively solidify portions of each layer under computer control to produce the 3D object.

### DESCRIPTION OF THE DRAWINGS

Certain examples are described in the following detailed description and in reference to the drawings, in which:

FIG. 1 is a block diagram of a 3D printer in accordance with examples of the present techniques;

FIG. 2A is a block diagram of a 3D printer in accordance with examples of the present techniques;

FIG. 2B is a block diagram of a 3D printer in accordance with examples of the present techniques;

FIG. 3 is a block diagram of a 3D printer in accordance with examples of the present techniques;

FIG. 4 is a schematic diagram of a 3D printer in accordance with examples of the present techniques;

FIG. 5 is a block diagram of a 3D printer in accordance with examples of the present techniques;

FIG. 6A is a block diagram of a thermal fusion system in accordance with examples of the present techniques;

FIG. 6B is a block diagram of a 3D printer in accordance with examples of the present techniques; and

FIG. 7 is a block flow diagram of a method of operating a 3D printer in accordance with examples of the present techniques.

### DETAILED DESCRIPTION

The cost of a 3D printer producing 3D objects may be directly related to the cost of build material. In addition, increased costs may result from dedicated resources external to the printer, extra floor space, and external equipment that may be utilized with some printers for mixing and extraction of build material.

Examples of the techniques described herein provide for a 3D printer that may receive new material. The 3D printer may also handle recycle material. In some examples, the 3D printer may have a closed-loop or substantially closed-loop material handling system for transporting material internally within the 3D printer. Certain examples may generally not use external dedicated resources, floor space separate from the printer, or external equipment to mix powder or extract 3D objects from unfused powder. In addition, the techniques described herein may facilitate handling of recycle material. In examples, recycle material within a 3D printer may be loaded into cartridges and then removed and stored for future use. Furthermore, the techniques described herein may provide for clean adding and removing of material from the 3D printer. For particular examples, recycle material may remain substantially free of external contaminants, and closed-loop material handling may reduce the risk of unknown material entering the 3D printer, and so forth.

In one implementation, a material input to the printer is new material. A material input may also possibly or intermittently include recycle material, though it is more common for recycle material to be removed from the printer rather than being used as an input to the printer. Again, the recycle material may be produced as a result of printing operations and is stored internally. However, the amount of recycle material may exceed internal storage capacity and be removed from the printer.

Some techniques for handling of build material by a 3D printer, and thermal fusion of the build material by the 3D printer to form a 3D object, are discussed herein. The build material may include new or fresh material, as well as recycle material recovered from the printer. The 3D printer may include a build enclosure and an associated build platform on which the 3D printer forms a 3D object from the build material. As discussed below, the printer may incrementally lower the build platform as each layer of the 3D object is printed or formed.

The 3D printer may have a cartridge receiver that holds a material cartridge. The material cartridge may be a housing or canister to contain the material. The cartridge receiver that holds or retains the material cartridge may be a cavity, receptacle, slot, sleeve, or any combinations thereof. Again, the 3D printer may form the 3D object from the material. The material may be made from one or more of metal, plastic, polymer, glass, ceramic, or other material. The material cartridge in the cartridge receiver may receive material from the 3D printer and make material available to the 3D printer for printing of the 3D object. A printer conveying system may transport the material to a thermal fusion system for printing. At least a portion of the thermal fusion system of the printer may be adjacent to or above the build enclosure.

The 3D printer may include a build-material applicator, such as a powder spreader or powder spreader arm, to distribute the build material layer-by-layer across the build platform. The build-material applicator may include additional components to facilitate receipt and discharge or distribution of powder to the build enclosure and build platform.

The thermal fusion system may include a printbar to eject print liquid, such as a fusing agent and other agents, onto the build material placed on the build platform. The printbar may have nozzles to eject the print liquid. For example, the printbar may eject the print liquid to specific points or areas of the build material surface under the control of a 3D model to form the 3D object layer-by-layer.

The thermal fusion system may include an energy source to apply energy, such as heat or light, to the build material and thus to the print liquid ejected onto the build material to facilitate fusion of the build material (e.g., powder) at the points or areas where the print liquid is applied to the build material. In certain examples, the energy source may apply energy substantially uniformly across the build material on the build platform. In some examples, the print liquid as a fusing agent may increase absorption of energy by the build material where the print liquid is applied. The thermal fusion system may also include one or more movement devices, such as a carriage(s), to hold, move, and position the printbar and/or energy source over the build material on the build platform.

A 3D printer may have one or more cartridge receivers to receive material cartridges, and the thermal fusion system as a thermal processing or fusion module to fuse material to form the 3D object. In a 3D printer having two cartridge receivers, one cartridge receiver may receive a first cartridge containing new material. The other cartridge receiver may receive a second cartridge containing recycle material or may receive an empty cartridge to collect build material from the 3D printer. Recycle material may be excess material from a build enclosure not fused during the generation of the 3D object. Recycle material may be referred to as reclaimed or reclaim material, recycled material, excess material, unfused material, etc.

Recycle material cartridges may be removed and stored for future use or discarded. Once a fresh material cartridge has been emptied by the 3D printer, the empty fresh material cartridge may be inserted into the second cartridge receiver to receive unfused or recycle material. Moreover, the 3D printer may include multiple internal vessels to store fresh material received from the fresh material cartridge or recycle material received from either the recycle material cartridge or the build enclosure. In one implementation, a new material cartridge (e.g., fresh powder container) is emptied into an internal vessel or hopper, and fresh or new material used by the printer is taken from this internal vessel as build material for the printer to form the 3D object. However, in another implementation, there is no internal vessel or hopper, and fresh or new material is taken directly from the new material cartridge for the printer to form the 3D object.

Certain examples of a 3D printer receive a material cartridge and may have one or multiple material cartridge receivers (e.g., slots) to secure the material cartridge. The material cartridge may be operationally removable from the material cartridge receiver or slot. A slot with a material cartridge therein may both provide material to the 3D printer and recover material from the 3D printer. In particular examples, the 3D printer may have two slots, one for “new” material and a second for “recycle” material. Other examples may have more than two slots for material cartridges, or a single slot for a material cartridge. The new or fresh material slot may hold a material cartridge that supplies, makes available, or otherwise provides new material as build material to the build enclosure for printing of the 3D object. In contrast, the recycle material slot may hold a material cartridge that receives material from the 3D printer such as from the build enclosure. The material entering the material cartridge in the recycle material slot may be surplus material left over from the printing of the 3D object. The recycle material slot may also hold the material cartridge to make available recycle material as build material to the build enclosure for printing of the 3D object.

When a new material cartridge is substantially or fully depleted, e.g., when the 3D printer has consumed the contents of the material cartridge, the material cartridge may be removed by the user and re-purposed for later use in the recycle material slot. In one example, the empty cartridge as a recycle material cartridge in a slot or in a recycle material slot may receive excess or unfused powder from the printer during or at the conclusion of a print job. The material cartridge in the recycle material slot containing recycle material may then supply or otherwise provide recycle material for printing. Again, as mentioned, examples of 3D printers may have multiple slots for material cartridges.

User removal of the emptied new-material cartridge may generally occur soon or immediately after emptying, so the 3D printer can be replenished with more new material from another new material cartridge to be inserted. However, the re-installation or re-use of the empty and now “recycle” cartridge may not occur for some time. The empty recycle cartridge may be stored away from the printer until recycle material is to be received by the 3D printer. In other words, the user may retain the recycle cartridge in storage external to the printer for future use by the printer. Indeed, the user may store many of the empty recycle cartridges. The 3D printer may request the user to re-install an empty or not completely-full recycle cartridge in a slot such as the recycle material slot. Moreover, multiple material types may be employed by a 3D printer at different times and therefore labels, markings, indicators, or other techniques may facilitate accounting of recycle material types in the recycle cartridges.

As indicated, a purpose of the recycle material cartridge and associated slot in the 3D printer may be to receive excess material from the build enclosure and, therefore, facilitate offloading of excess material from the printer. In other words, a recycle cartridge in the single slot or the second slot of the 3D printer may receive excess material from the build enclosure during or after printing. The excess material may be build material from the build enclosure that did not become fused into the 3D object.

Full or partially-filled recycle cartridges may supply recycle material to the build enclosure, or be removed for future use, and the like. In other words, some of these cartridges filled with recycle material may remain in place in the printer slot, or be removed and stored or discarded. Some of these recycle cartridges filled with recycle material may be removed and kept for future use when the 3D printer is short of recycle material to be mixed with new material and utilized or consumed during printing. In certain examples of a 3D printer with a single slot for a material cartridge, a new material cartridge may be inserted into the slot and have the contents thereof emptied into an internal storage vessel of the printer. The cartridge could then become a recipient for recycle material.

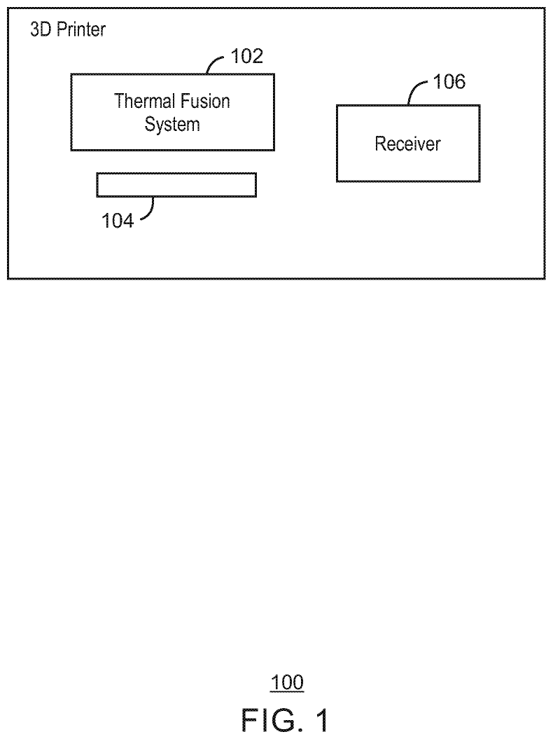

FIG. 1 is a 3D printer 100 having a thermal fusion system 102, a build platform 104, and a cartridge receiver 106. The thermal fusion system 102 may selectively fuse portions of successive layers of a build material on a build platform 104 to print or form a 3D object. Indeed, the 3D printer may place build material, e.g., powder, on the build platform 104 to generate the 3D object. The thermal fusion system 102 may operate or function at least partially over the build platform 104 to form the 3D object.

As mentioned, the thermal fusion system 102 may include a printbar to eject print liquids, such as a fusing agent, onto the build material on the build platform 104. In addition, the thermal fusion system 102 may include an energy source to apply energy to the fusing agent ejected onto the build material to selectively fuse portions of successive layers of build material on the build platform 104. Further, the thermal fusion system may include a movement device to position the printbar or the energy source over the build platform 104. The movement device may be, for example, a carriage or other type of movement device. More than one movement device may be employed.

An aspect of the discussion of FIG. 1 may also be applicable to the printer 100 as a selective-laser-sintering printer. The thermal fusion system 102 is a selective solidification module performing, via applied energy (e.g., laser), selective laser sintering (SLS) or similar 3D printing techniques. In other examples, the printer 100 is not a selective-laser-sintering printer, and the thermal fusion system 102 performs, via applied energy and print liquid, fusion for selective solidification. Other configurations are applicable.

The 3D printer 100 may employ the cartridge receiver 106 to hold a material cartridge. The cartridge receiver 106 may be a cavity, a receptacle, a slot, a sleeve, or any combinations thereof. The material cartridge may be an enclosure to contain or retain the material. In some examples, the material cartridge may be sealed or substantially sealed to prevent or reduce build material from leaking or escaping to the environment when the material cartridge is removed from the printer. This may facilitate a clean and convenient method for handling of material. The material cartridge may be inserted or installed into the cartridge receiver 106. The material cartridge held by the cartridge receiver 106 may accept excess material from a build enclosure associated with the build platform 104, and make material available to the build enclosure and build platform 104 for printing of the 3D object. Alternatively, or in addition, material stored in an internal storage vessel may be fed to the build enclosure. The printing of the 3D object may involve the formation of the 3D object from the material in the material cartridge. The material may be build material which may be a powder composed of plastic, polymer, metal, glass, ceramic, or any combinations thereof.

In some examples, the 3D printer 100 may include an integrated feed vessel or dispense vessel to receive the material made available by the cartridge receiver 106 from the material cartridge. In certain examples, a powder handling system including a powder spreader may receive the material from the feed vessel, and disperse the material as build material across a surface of the build platform 104 associated with the build enclosure.

The powder handling system may include a feed apparatus to receive build material from the feed vessel and provide the build material to the powder spreader. Lastly, in this example, the powder spreader is not a component of the thermal fusion system 102. However, in another example, the powder spreader may be considered a component of the thermal fusion system 102. In either case, the powder spreader or similar component may distribute the build material across the build platform 104.

Again, the powder handling system, which may be downstream of the feed vessel, may include a feed apparatus (e.g., a dosing device), a powder spreader, and other components. In some examples, the feed apparatus receives build material from the feed vessel. In other words, the feed apparatus may receive build material from the feed vessel via the conveying system. The feed apparatus may discharge or dose build material for the powder spreader to distribute the dosed build material across the build platform 104. In one example, the feed apparatus discharges a line or ribbon of build material for the powder spreader to distribute across the build platform 104.

A printbar may selectively eject (e.g., based on a 3D object model of the object to be generated) a fusing agent onto the build material on the build platform 104 for the first layer of the 3D object. An energy source, such as a light source or heat source, may selectively fuse, or cause selective fusion of, the material on the build platform 104 to form a layer of the 3D object. The powder spreader or other build-material applicator may disperse more material across the surface of the build platform 104 to form the next layer. The printbar may eject further fusing agent onto the material on the build platform 104 and apply energy to form the next layer. Indeed, the additional material may be selectively fused to form the next layer (a second layer) of the 3D object. This repeated dispersion of build material onto the build platform 104 and ejection of fusing agent onto the build material on the build platform 104 (and application of energy) may continue for successive layers until the 3D object is, for example, completely formed or substantially-completely formed. In certain examples, as discussed below, the printbar and the energy source may be components of the thermal fusion system. In some examples, the thermal fusion system, as well as the powder spreader or build-material applicator, may be disposed at least partially above the build enclosure and the build platform 104.

The cartridge receiver 106 may be a recycle cartridge receiver. As such, the material cartridge may be a recycle material cartridge. Note, however, the cartridge receive 106 may not be a dedicated recycle-cartridge receiver in certain examples. In other words, the printer 100 may include conduits or ducting and associated control valve(s) that provide for flexibility in the designation of the cartridge receiver 106.

The recycle material cartridge may contain recycle material. Recycle material may be excess or unfused material left over from the 3D printing. In some examples, the printer 100 may include a build-material reclaim system to separate unfused build material from fused build material after the generation of a 3D object. The cartridge receiver 106 may provide or make available recycle material from the recycle material cartridge for the build enclosure and build platform 104. At the build enclosure, the 3D object is formed from the recycle material on the build platform 104. Generally, each layer of build material processed on the build platform 104 may be a mix of new build material and recycle build material, although the build material or a layer of build material on the build platform may be all new material or all recycle material.

Again, the thermal fusion system 102 may be disposed at least partially over the build enclosure. Moreover, the build enclosure and the associated build platform 104 together may constitute a build unit. In certain examples, the build unit may be operationally removable. While FIG. 1 depicts a build platform 104, the printer 100 may be manufactured and sold without the build platform 104.

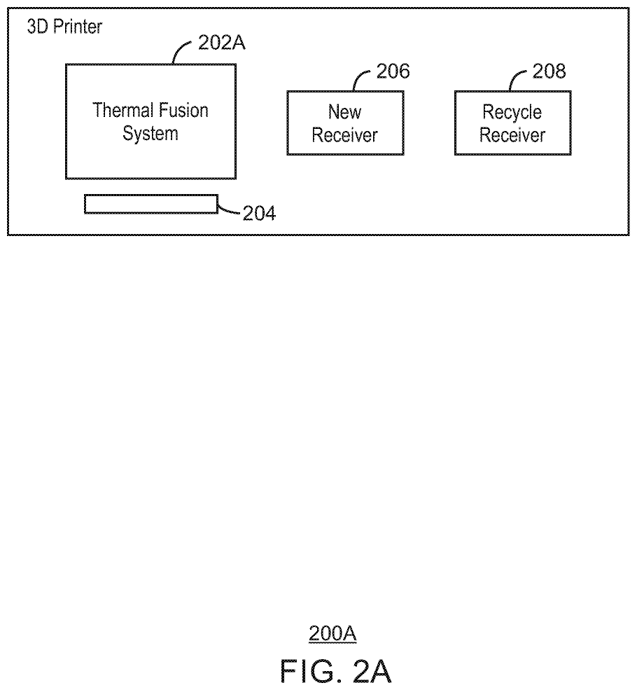

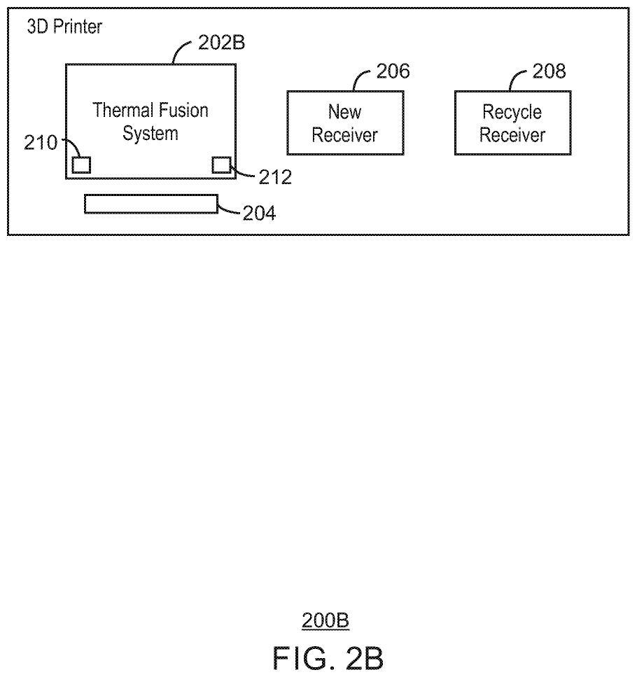

FIG. 2A is a 3D printer 200A having a thermal fusion system 202A to selectively fuse portions of successive layers of build material on a build platform 204. The thermal fusion system 202A may include a printbar, an energy source, a movement device, and other components. The printbar may eject print liquid onto the build material on the build platform 204. The print liquid may include a fusing agent which promotes thermal fusion, a detailing agent, e.g., water, which inhibits fusion, a coloring agent, and other compounds. In some examples, different print liquids may be separately applied, or applied through separate nozzles of the print bar, and the like. In one example during color printing, at least seven printing agents may be employed. Again, some of these agents may be for fusing, others are for coloring, and another labeled a detailing agent to inhibit fusing, and so on.

In operation, the printbar may be positioned over the build platform 204 by the movement device. The energy source may apply energy to the build material on the build platform 204 and, therefore, to the fusing agent ejected onto the build material to selectively fuse portions of successive layers of build material on the build platform 204. The energy source may be a light source or heat source, or both. The movement device may position the printbar or energy source, or both over the build platform 204. The movement device may be a carriage. Moreover, the printbar and the energy source may be carried and positioned by different movement devices. Indeed, such separation of the printbar from the energy source may reduce exposure of the print bar to heat from the energy source.

The 3D printer 200A may include a new cartridge receiver 206 to hold a new material cartridge. The new cartridge receiver 206 and the new material cartridge may make new material available to the thermal fusion system 202A and a build enclosure associated with the build platform 204 for printing of a 3D object. The printer 200 may also include a recycle cartridge receiver 208 to hold a recycle material cartridge. The recycle cartridge receiver 208 and the recycle material cartridge may make recycle material available to the thermal fusion system 202A and the build enclosure for printing of the 3D object. In some examples, the new material cartridge holding new material may be inserted into the recycle cartridge receiver 208.

The 3D printer 200A may feed, via a conveying system, new material and recycle material to the thermal fusion system 202A and the build enclosure at a specified ratio of new material to recycle material. The ratio may range from zero, e.g., no new material, all recycle material, to 1.0, e.g., all new material, no recycle material. The ratio may be a weight ratio, volume ratio, or other type of ratio. The ratio as a weight ratio may range from 0.01 to 0.99, 0.05 to 0.95, 0.1 to 0.9, 0.15 to 0.85, 0.2 to 0.8, 0.25 to 0.75, 0.3 to 0.7, etc. In a particular example, the feed to the thermal fusion system 202A and build enclosure may be 20% new material by weight and 80% recycle material by weight, yielding a weight ratio of 0.25. In another example, the feed has 20% new material by volume and 80% recycle material by volume, yielding a volume ratio of 0.25.

FIG. 2B is a 3D printer 200B similar to the 3D printer 200A of FIG. 2A. The 3D printer 200B may include a thermal fusion system 202B to fuse portions of layers of build material on a build platform 204 to form a 3D object. The 3D printer 200B may also include a new cartridge receiver 206 to receive a new material cartridge, and a recycle cartridge receiver 208 to receive a recycle material cartridge. As discussed, the 3D printer 200B may feed both new material as build material and recycle material as build material to the build platform 204. The 3D printer 200B may include a build material applicator, e.g., a powder spreader or powder spreader arm, to disperse the build material across a surface of the build platform 204. In some examples, the build material applicator may be disposed on a movement device such as a carriage. The build material applicator may have a mechanical arm to spread or disperse build material.

The thermal fusion system 202B may include a printbar 210 and an energy source(s) 212. The printbar 210 may move across the build platform 204 and eject a fusing agent onto the build material on the build platform 204. The printbar 210 may be disposed on a movement device, e.g., a carriage, that positions the printbar 210 above the build platform 204. The printbar 210 may eject fusing agent via multiple nozzles of the printbar 210. The energy source(s) 212, such as a light source or heat lamp, may move across the build platform 204 and apply energy to the fusing agent ejected onto the build material on the build platform 204 to selectively fuse the material to print a layer of the 3D object being formed. The energy source 212 may be carried by or associated with a movement device, such as a carriage, that locates or positions the energy source 212 above the build platform 204. In some examples, an energy source 212 may be static and not operationally movable.

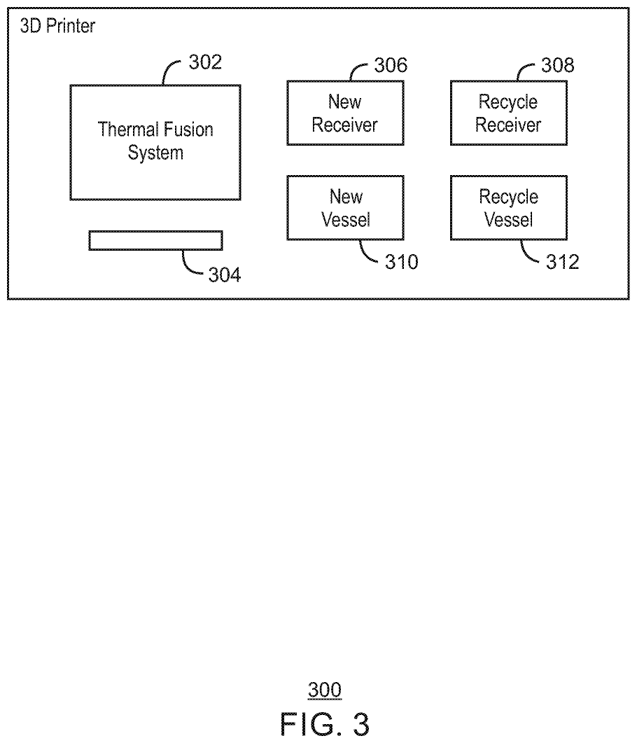

FIG. 3 is a 3D printer 300 having a thermal fusion system 302 to fuse build material on a build platform 304 to form a 3D object. As indicated for some examples, the printer 300 and its thermal fusion system 302 may selectively fuse portions of successive layers of the build material on the build platform 304. As discussed, the thermal fusion system 302 may include a printbar to eject a fusing agent onto the build material on the build platform 304, a movement device to position the printbar over the build platform 304, and an energy source to apply energy to the fusing agent ejected onto the build material to fuse portions of layers of the build material on the build platform 304. The movement device or a second movement device may carry and position the energy source over the build enclosure and build platform 304. In some examples, an energy source may be static and not moved during printing.

The 3D printer 300 may also include a new cartridge receiver 306 to hold a new material cartridge, and a recycle cartridge receiver 308 to hold a recycle material cartridge. The printer 300 may include a new material vessel 310 disposed internal to the printer 300 and near the new cartridge receiver 306 to receive new material from the new material cartridge in the new cartridge receiver 306. Likewise, a recycle material vessel 312 may be disposed internal to the printer 300 and near the recycle cartridge receiver 308 and may receive recycle material from the recycle material cartridge in the recycle cartridge receiver 308. The new material and recycle material may be gravity fed or otherwise conveyed to the new material vessel 310 and the recycle material vessel 312, respectively. In one example, the receivers 306 and 308 discharge material from cartridges by gravity to the vessels 310 and 312, respectively. In particular examples, air flow through the conduits (e.g., tubing, piping, etc.) connecting the receivers 306 and 308 to the vessels 310 and 312 may promote flow of the material or supplement the gravity transport of the material.

Moreover, the vessels 310 and 312 may be removed from the 3D printer 300 and emptied. Alternatively, the vessels 310 and 312 may be emptied by feeding material from the vessels 310 and 312 to the thermal fusion system 302 or build enclosure and build platform 304. If the vessels 310 and 312 are filled with or have material, the 3D printer may operate without the insertion of material cartridges in certain examples. Lastly, in some instances, the material cartridges in the cartridge receivers 306 and 308 may be rotated within the 3D printer 300 to de-aggregate material that has been stored for extended periods of time in the 3D printer 300.

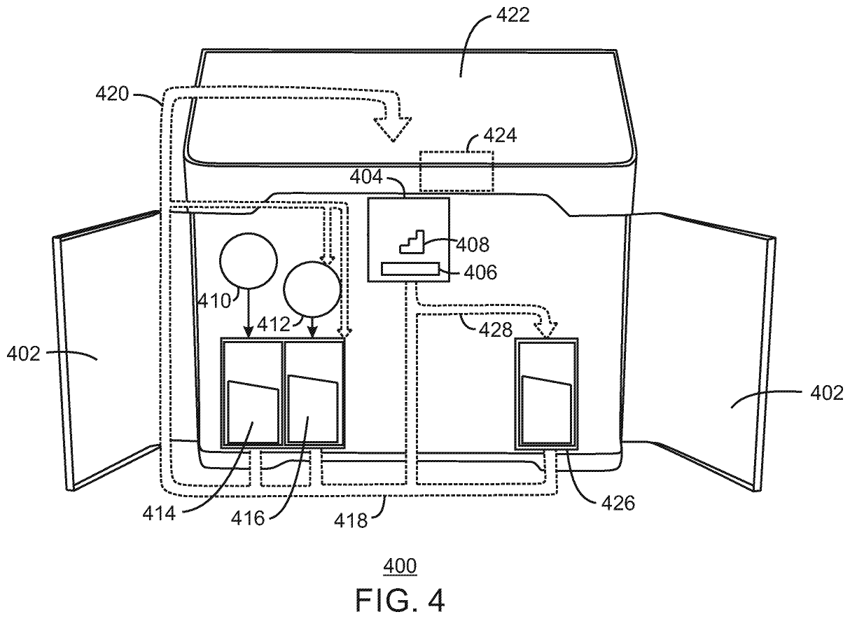

FIG. 4 is a schematic diagram of a 3D printer 400. The 3D printer 400 is shown with its front access panels 402 open and an interior portion visible. The 3D printer 400 may include a build enclosure 404. The build enclosure 404 may be associated with a build platform 406 on which a 3D object 408 is formed from feed material composed of a mix, as described above, of new material and recycle material. The 3D printer 400 may include a new cartridge receiver 410 that receives and holds a new material cartridge to make new material available from the new material cartridge to the 3D printer 400. The 3D printer 400 may include a recycle cartridge receiver 412 to receive and hold a recycle material cartridge to accept excess material from the build enclosure 404. In addition, the recycle cartridge receiver 412 may make recycle material available from the recycle material cartridge to the 3D printer 400. In particular instances, the new material cartridge may rotate in the new cartridge receiver 410 to prevent, reduce, break up, or dislodge agglomeration of the powdered new material. Likewise, the recycle material cartridge may rotate in the recycle cartridge receiver 412 to prevent or reduce agglomeration of the powdered recycle material. If such rotation is employed, the new material cartridge and the recycle material cartridge may be filled or emptied when the cartridges are rotating in particular instances. In some examples, rotation is not employed. In other words, in those examples, the printer 400 and the cartridge receivers 410 and 412 do not provide for rotation of the material cartridges to reduce agglomeration. Moreover, the printer 400 may determine when an internal recycle vessel or hopper is full and instruct a user to insert an empty material cartridge which can then be filled with recycled material from the full internal recycle vessel.

The 3D printer 400 may include a new material vessel 414 to receive new material from the new material cartridge, and a recycle material vessel 416 to receive recycle material from the recycle material cartridge. The new material from the new material vessel 414 and the recycle material from the recycle material vessel 416 may be provided to a conveyance system. The new material and the recycle material may intermingle or mix in-line as the material moves through the conveyance system. In one example, a mixing device such as a baffle or static mixer is employed in-line in the conveying conduit. In another example, the conveying system is a pneumatic conveyance system in which the material is conveyed at a relatively high velocity which may promote mixing. The mix of new material and recycle material may be supplied to the thermal fusion system 424 and build platform 406.

In FIG. 4, a dashed box is a representation of the thermal fusion system 424 which may include several components, including components that operationally move over the build enclosure and build platform 106. The thermal fusion system 424 may include a printbar to eject print liquid, such as a fusing agent, onto the build material on the build platform 406. In some examples, the printbar may have nozzles to eject the print liquid or fusing agent. Moreover, the print liquid may be ejected at particular points, lines, or regions on the build material to fuse those portions of the build material in forming each layer of the printed 3D object 408. The movement and positioning of the printbar over the build platform 406, and the directing of the ejected print liquid, may be per a 3D model under computer control. Further, the thermal fusion system 424 generally includes an energy source to apply energy to the fusing agent ejected onto the build material on the build platform to selectively fuse the build material to form a layer (or layers) of the 3D object 408.

In this example, the 3D printer 400 has doors or access panels 402 and a top surface 422. Indeed, the printer 400 may generally have a partial or overall enclosure to house printer 400 components. Some printer 400 components may be readily removable or operationally removable, whereas other printer 400 components may be more static or intended to not be regularly removed. Lastly, the conduits denoted by reference numerals 418 and 420 are representations of general flow of material or powder. The printer 400 conduits (e.g., piping, tubing, etc.) associated with such flow of material may be housed inside the printer 400 in some examples.

Excess material (e.g., unfused material) may be conveyed from the build enclosure 404 to the recycle material cartridge in the recycle cartridge receiver 412, or to the recycle material vessel 416. Excess material may also exit the build enclosure 404, such as under a vacuum, and enter a reclaim vessel 426 which may be a second recycle material vessel in certain examples. Excess material 428 may be transported through a manifold or conduit(s) from a bottom portion (or other portions) of the build enclosure 404 to the reclaim vessel 426. In addition, or if there is no reclaim vessel 426, excess material 428 recovered from the build enclosure 404 may proceed directly to a conduit(s) transporting recycled material 418. In some examples, the excess material 428 may be subjected to filtering, separation, or other processing to remove larger particles, air, and so forth, prior to the excess material entering the reclaim vessel 426.

A build unit processing module may include or involve a build unit including the build enclosure 404 and the build platform 406. The build platform 406 may have holes to allow unfused powder to flow through the build platform 406. In addition, the build processing module may include sieves, vibration sources such as a motor with an eccentric or off-center mass, air flow devices, and other components to remove excess build material, e.g., unfused powder, from the build platform 406. The 3D object 408 disposed on the build platform 406 may cool naturally or at an accelerated rate depending on when the unfused material or powder is removed from the build enclosure 404. In other words, the 3D object 408 may cool faster with surrounding excess build material removed. In this fashion, the build unit processing module may manage the cooling process, e.g., by removing the excess build material. The build unit processing module may provide for discharge of excess material 428 from the build enclosure 404.

After most or all of the excess or unfused material or powder is removed from the build enclosure 404, the build enclosure 404 may have a 3D object 408 with partially-fused powder caked on the outside of the 3D object 408. In certain examples, this partially-fused powder may be removed by a bead blaster, a brush, or other tools that may be part of the build unit processing module. Partially-fused powder may be removed from the build enclosure 404. Partially-fused powder may be removed from the 3D object in the build enclosure 404 or after the 3D object has been removed from the build enclosure 404.

Furthermore, in some examples, the printer 400 may have a 3D printed object recovery zone. Indeed, once some or most of the unfused powder has been removed from the 3D object 408 (and from the build enclosure 404), the 3D object 408 may be recovered via the 3D printed object recovery zone in those examples. In operation, the build platform 406 may be manually or automatically lifted to, or towards, the top of the build enclosure 404 to the recovery zone so that a user may recover the 3D object 408. In an example, this 3D printed object recovery zone may be accessed by a user or machine through a top or side opening of the 3D printer 400. The opening may be through an outer housing or casing of the 3D printer 400. In some examples, the zone may be accessed by lifting a lid or a removable top of the 3D printer 400. In other examples, a door(s) of the 3D printer may be opened to access the zone. The recovery zone may include tools to remove any remaining free build material or powder from the 3D object 408 and to clean the build platform 406. The 3D printed object recovery zone may also include containers to store printed 3D objects, a light source to illuminate the zone, and devices to provide air flow to prevent or reduce excess build material from exiting the 3D printer 400 during recovery of the printed 3D object.

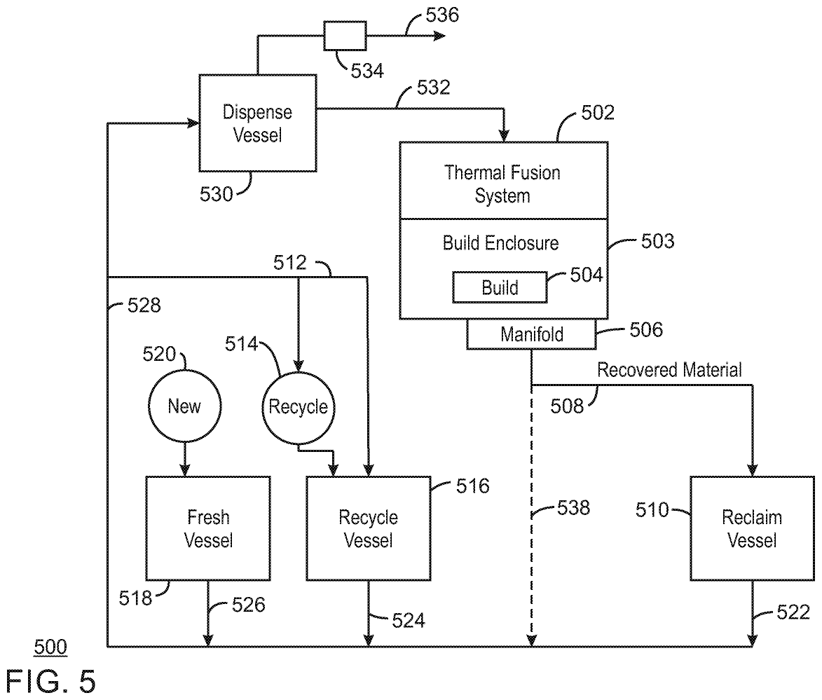

FIG. 5 is a 3D printer 500 having a thermal fusion system 502, a build enclosure 503, and a build platform 504 associated with or at least partially within the build enclosure 503. In some examples, the build enclosure 503 at least partially contains the build platform 504. Feed material, e.g., feed powder or build material, may be provided to the thermal fusion system 502 or to the build enclosure 503. A manifold 506 may withdraw excess material or excess powder, e.g., unused powder, from the build enclosure 503 as recovered material 508. In examples, this is performed after generation of the 3D object is complete. In one example, this withdrawal of excess material from the build enclosure 508 is performed only after completion of the generation of the 3D object or after completion of the print job. In another example, the withdrawal of excess build material is performed both during the print job and after completion of the print job.

The manifold 506 may be coupled to a motive component (not shown) such as a vacuum pump, a blower, a venturi, or any combinations thereof. The recovered material 508 may be conveyed via the manifold and motive component to a reclaim vessel 510. The recovered material may bypass the reclaim vessel 510, as indicated by reference numeral 538, and be transported via a feed conveying system to, for example, a recycle material cartridge in a recycle cartridge receiver 514 or to a recycle material vessel 516, as indicated by reference number 512. The recycle material vessel 516 may also be provisioned by the recycle material cartridge in the recycle cartridge receiver 514. Likewise, a new material vessel 518 may be supplied by a new material cartridge in the new cartridge receiver 520.

Moreover, the recovered material 508 may be combined with recycle material 524 and fresh or new material 526. The recycle material vessel 516 and the new material vessel 518 may provide the recycle material 524 and new material 526, respectively. In some examples, the recycle material 524 and the new material 526 may be provided to give a desired or specified ratio (e.g., weight ratio or volume ratio) of new material 526 to recycle material 524. The recovered material 508 may have the desired or specified ratio of new material 526 to recycle material 524, or may be classified as recycle material. The feed material 528 fed to the dispense vessel 530 and thermal fusion system 502 may include recycle material 524, new material 526, or the recovered material 508, or any combinations thereof. The various materials 524, 526, and 508 may mix in-line as the feed 528 is in route to the dispense vessel 530 in certain examples.

In some examples, the feed 528 may include recovered material 522 from the reclaim material vessel 510, recycle material 524 from the recycle material vessel 516, and new material 526 from the new material vessel 518. In examples or operations without recovered material 522, the new material 526 and recycle material 524 may form the feed material 528 as the material is transported to a dispense vessel 530. The dispense vessel 530 may provide the feed material 528 as build material 532 to the thermal fusion system 502. Alternatively, the dispense vessel 530 may provide the build material 532 to the build platform 504. A control system may facilitate the feed material 528 composition and build material 532 composition having a specified ratio of new material to recycle material. The control system may deliver a specified ratio by metering the weight or volume of material dispensed from the new material vessel 518 and recycle material vessel 516.

In the illustrated example, the reclaim material 522, recycle material 524, and new material 526 may be fed as feed material 528 to a dispense vessel 530. The 3D printer 500 may include a conveying system to facilitate transport of the feed material 528 to the dispense vessel 530 and to the build enclosure 503. In some examples, a pneumatic conveying system is employed. If so, the pneumatic conveying system may include a vacuum component 534 which may be a venturi or blower, or both. The pneumatic conveying air 536 may discharge through the vacuum component(s) 534. The feed material 532 minus most or all of the conveying air may flow, e.g., by gravity, air flow, etc., from the dispense vessel 530 to the build enclosure 503 or other printer components for printing of a 3D object on the build platform 504.

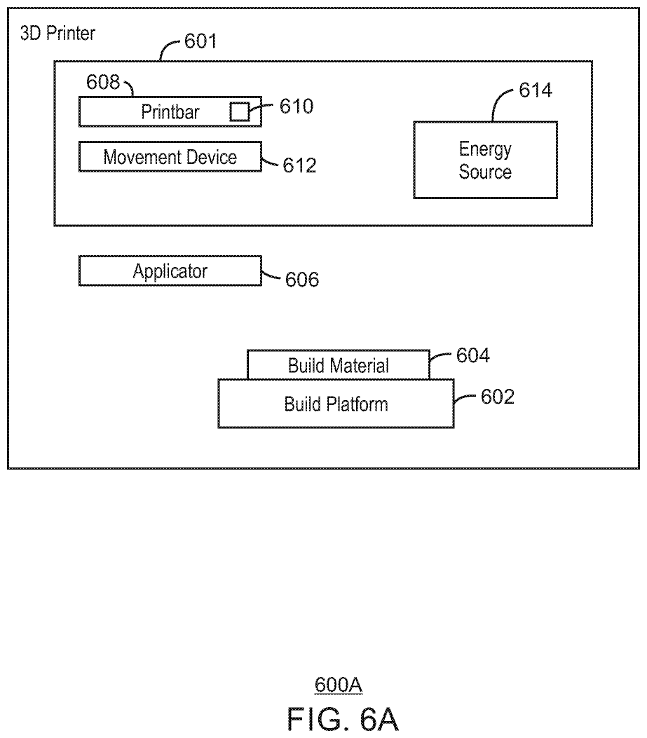

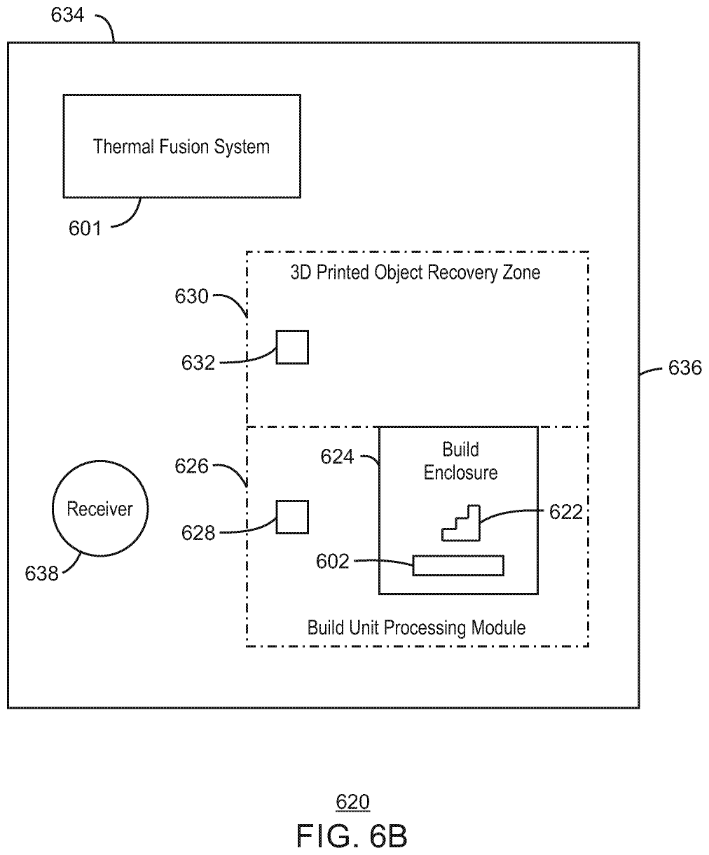

FIG. 6A is a 3D printer 600 having a thermal fusion system 601. The thermal fusion system 601 may be situated adjacent to and above the build platform 602. In operation, the 3D printer 600A may place or deposit build material 604 onto the build platform 602. The printer 600A may include a build-material applicator 606. In examples, the build-material applicator 606 may be a powder spreader or powder spreader arm. The applicator 606 may include additional components and more than one powder spreader. The build-material applicator 606 may disperse build material 604, e.g., powder, across a surface of the build platform 602. The build-material applicator 606 may be a component separate from the thermal fusion system 601, as depicted in the illustrated example. In other examples, the thermal fusion system 601 may include the build-material applicator 606. In examples, the build-material applicator 606 may be on the same movement device as the energy source 614.

The thermal fusion system 601 may also include a printbar 608 having nozzles 610 to eject a fusing agent onto the build material 604 on the build platform 602. A movement device 612 may position the printbar 608 above the build platform 602. The thermal fusion system 601 may also include an energy source(s) 614 to facilitate fusing of the build material 604 to form layers of a 3D object. In some examples, the movement device 612 or another movement device of the thermal fusion system 601 may move and position the energy source 614. In certain examples, the energy source 614 may be static.

To print a 3D object, the thermal fusion system 601 may eject a fusing agent through the nozzles 610 of the printbar 608 onto the build material 604 or powder, and apply energy from the energy source 614 to the ejected liquid on the build material 604 to fuse build material 604 to form the 3D object layer-by-layer from the build material 604. The energy source 614 may be a light source or a heat source to apply light or heat to the fusing agent for each layer. The light source or heat source may be a heat lamp, an infrared (IR) light source, etc. As used herein, a light source may be considered or called a heat source such as when the light source is an IR light. In certain examples, fusing lamps are employed and may be labeled as a light source or a heat source.

As used herein, the term “powder” as build material 604 can, for example, refer to a powdered, or powder-like, material which may be layered and fused via a fusing agent during a 3D print job. The powdered material can be, for example, a powdered semi-crystalline thermoplastic material, a powdered metal material, a powdered plastic material, a powdered composite material, a powdered ceramic material, a powdered glass material, a powdered resin material, or a powdered polymer material, among other types of powdered material. In some instances, the powder may be wet from capturing moisture during use of the powder in a humid environment, or the powder may be pre-mixed with water. Hence, build material may be generalized to include wet powder, slurries, suspensions, gels, etc.

As mentioned, the printbar 608 may include multiple print nozzles 610 to eject the fusing agent. In some examples, the nozzles 610, if employed, may reside on, or be a component of, substructures on the printbar 608. The substructures may be, for example, dies, pins, printheads, or other substructures. Moreover, the number of print nozzles 610 can range up to hundreds or thousands, or more. In one example, the number of print nozzles 610 is less than 500 nozzles. In another example, the number of print nozzles 610 ranges from 10,000 to 70,000 nozzles.

The diameter of the print nozzles 610 can be as small as 70 microns or less. The diameter can be 5 microns, 10 microns, 15 microns, 30 microns, or 50 microns, or any value in between. In one example, the nozzle diameter ranges from 5 microns to 30 microns. The diameter can be greater than 70 microns. The diameter of the nozzles 610 may be determined, in part, by the number of nozzles 610 present on the printbar 608.

The ejection of the fusing agent through the nozzles 610 may be via pressure differential, a pump, heating elements, thermal bubble, bubble jet, piezoelectric techniques, and so on. If heating elements are employed, the heating elements may be resistors in some examples. The piezoelectric techniques may include piezo crystals to which voltage or current is applied.

The thermal fusion system 601 may include the printbar 608, and any additional printbars, which may reside in or on a movement device 612, such as a carriage or other positioning apparatus. The 3D printer 600A and its thermal fusion system 601 may have a motor(s) to move the carriage. The movement of the movement device 612 may position the printbar 608 over the build platform 602, or in a rest position or servicing position, and so forth. One or more movement devices 612 may also carry movable components such as an energy source 614, a powder spreader or powder spreading arm, and other devices.

A 3D printer may print or form a 3D object via the fusing agent. As discussed, in certain examples, the fusing agent may be ejected from the nozzles 610 onto the build material 604 on the build platform 602. Build material 604 may include powder, such as plastic powder or metal powder. In one example, the powder is Nylon powder. In another example, the powder is metal powder such as stainless steel powder. In general, the printbar 608 may lay the fusing agent on the powder. As indicated, an energy source 614, e.g., a light source, a heat source, a heat lamp, a combined light/heat source, etc., may fuse powder in combination with the fusing agent. Indeed, the energy from the energy source 614 applied to the fusing agent on the build material 604 may facilitate greater incorporation of energy into the powder where the fusing agent is applied. In certain examples, the energy source 614 is operationally movable, and the printer positions the energy source 614 during printing. The energy source(s) 614 may be operationally movable, stationary, or static, or a combination thereof. Moreover, it should be noted that the energy source 614 may be a light source to apply light, but is a heat source in the sense that an effect of applying the light is that heat is applied. Therefore, in that example, the energy source 614 may be called a heat source or light source.

The 3D object may be formed layer-by-layer, e.g., layers of about 80 microns in thickness. As indicated, the selectively-applied fusing agent provides for greater absorption of heat or light by the powder topped with the fusing agent than the remaining powder lacking the fusing agent. The fused portions of powder may be where the fusing agent is applied. Indeed, specific points or areas of fusing agent application may be driven by computer control, such as under direction of a 3D model. Further, the printbar 608 may also eject detailing agents to further refine the 3D object.

Thus, a 3D printer may print or fabricate a solid 3D object. The solid object may be a complete product, a part of a product, a prototype, and so on. The 3D printing may make 3D solid objects from a digital file. An object may be created by laying down successive layers of build material until the object is created. In some instances, each of these layers can be seen as a thinly sliced horizontal cross-section of the completed object. A controller associated with the printbar 608 may control ejection of the fusing agent from the printbar 608 onto the build material 604. The controller may control the positioning of the printbar 608 over the build platform 602 in some examples.

Again, the build material 604 may reside on a build platform 602. To perform 3D printing, the 3D printer may have a build enclosure associated with the build platform 602. The build enclosure may be a build chamber, build bucket, and the like. The 3D printer may print or form, via the build platform 602, the 3D object from build material 604. For example, in operation, build material 604 may be disposed on the build platform 602. The build platform 602 may reside on a movement device, e.g., a piston, which is incrementally lowered as the 3D object is formed layer-by-layer. After completion of the print job, the 3D object may be removed from the 3D printer. In examples, the 3D object may be subjected to additional processing, such as post-processing, finishing, and so forth.

In FIG. 6A, the build-material applicator 606, the printbar 608, and the energy source 614 may reside at rest on the same side or different sides of the build platform 602. Further, as discussed, the thermal fusion system 601 may include at least one movement device 612. The printbar 608 and the energy source 614 may be disposed on or in the same movement device 612 or different movement devices 612. Movement options for the one or more movement devices 612 or carriages include in-line (left-to-right, right-to-left, front-to-back, and back-to-front), orthogonal, diagonal, irregular patterns, and so on.

The fabrication of the 3D object may be under computer control. A model and automated control may facilitate the layered manufacturing and additive fabrication. The model may be, for example, a computer aided design (CAD) model, a similar model, or other electronic data source. The 3D objects so formed can be various shapes and geometries.

The 3D printer may include a computer system having a hardware processor and memory. The hardware processor may be a microprocessor, central processing unit (CPU), an ASIC or other circuitry, printer control card(s), and the like. The processor may be one or more processors, and may include one or more cores. The memory may include volatile memory such as random access memory (RAM), cache, and the like. The memory may include non-volatile memory such as a hard drive, read only memory (ROM), and so forth. The computer system may include code, e.g., instructions, logic, etc., stored in the memory and executed by the processor to direct operation of the printer and to facilitate various techniques discussed herein.

As for product applications, a 3D printer may fabricate objects as prototypes or products including aerospace parts, machine parts, medical devices, e.g., implants, automobile parts, fashion products, structural and conductive metals, ceramics, conductive adhesives, semiconductor devices, and other products. In one example, the printer forms mechanical parts which may be metal or plastic, and which may be equivalent or similar to mechanical parts produced, for example, via injection molding.

FIG. 6B is a 3D printer 620 having the thermal fusion system 601 and the build platform 602 to form a 3D object 622 in 3D printing. In examples, as indicated in the discussion of the preceding figure, most or all of the thermal fusion system 601 may be disposed above the build platform 602. Moreover, in the present illustrated example, the printer 620 has a build enclosure 624 associated with the build platform 602. In certain examples, the build platform 602 may reside on a piston (not shown), such that the printer 620 may raise and lower the build platform 602 within the build enclosure 624. In some examples, the printer 620 may be able to raise the build platform 602 via the piston so that the upper surface of the build platform 602 reaches the top portion of the build enclosure 624 or extends out of the build enclosure 624.

In addition, the printer 620 includes a build unit processing module 626 which may involve or include the build platform 602 as having holes for excess build material or unfused powder to flow through the build platform 602. The processing module 626 may include components 628 to treat the 3D object 622 and process the unfused powder. The components 628 may be filters, sieves, separators, vibration sources, motors with an eccentric mass, and devices to provide air flow, and so forth, to process the unfused powder.

In operation, after the completion of a print job, the formed 3D object 622 and surrounding build material may cool naturally or at an accelerated rate, depending, for example, on when the unfused powder is removed from the build enclosure 624. Further, the formed 3D object 622 may be treated with some of the components 628 of the build unit processing module 626. For instance, after the excess build material (e.g., unfused powder) is removed, the printed 3D object 622 in the build enclosure 624 may have partially-fused powder caked on the outside of 3D object 622. This partially-fused powder can be removed via or with components 628 such as a bead blaster, brush, or other tools.

The printer 620 may have a 3D printed object recovery zone 630. The build platform 602 may be manually or automatically lifted toward the recovery zone 630. In other words, the build platform 602 may be raised toward and to the top of the build enclosure 624 to present the printed object 622 on the build platform 602 to a user or machine. In one example, the user can access the recovery zone 630 by lifting a lid at the top surface 634 of a housing of the printer 620. In another example, a door or opening on a side 636 of the housing may provide for access to the recovery zone 630. The recovery zone 630 may include components 632 to clean the 3D object 622 and the underlying build zone including, for example, the build enclosure 624. The components 632 may include tools to remove build material or powder from the printed object 622 and to clean the build zone. The components 632 may include containers to store the printed object 622 and other printed 3D objects formed or to be formed by the printer 620. The components 632 may include other equipment such as lights to illuminate the zone 630, air devices or fans to provide airflow to reduce the amount of build material that might exit the printer 620 housing during printed object recovery.

Lastly, the printer 620 may have an integrated cartridge receiver 638 to hold a material cartridge to supply build material for 3D printing, and to receive material from the 3D printing. The printer 620 may have more than one cartridge receiver 638. The printer 620 may additionally include integrated material vessels such as hoppers or containers to receive, store, and supply build material.

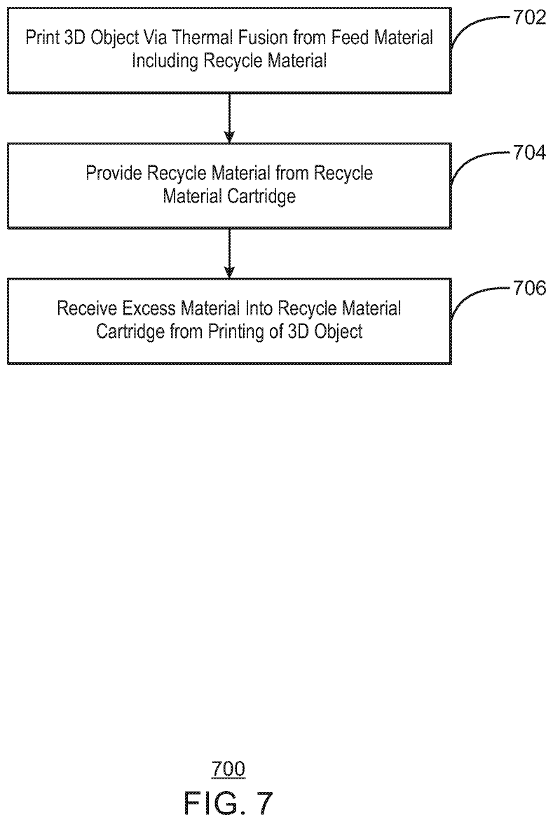

FIG. 7 is a method 700 of operating a 3D printer to form a 3D object. At block 702, the method includes the 3D printer printing a 3D object via thermal fusion from feed material that may include recycle material. The recycle material may be excess material that is unfused or otherwise not incorporated into the 3D object during 3D printing. At block 704, the method includes the 3D printer providing the recycle material from a recycle material cartridge for the printing. Alternatively, or in addition, the 3D printer may provide recycle material from a recycle material vessel. The recycle material cartridge may be disposed or inserted into an integrated recycle cartridge receiver of the printer. In some examples, the recycle material vessel may be disposed below the recycle cartridge receiver and supplied by the recycle material cartridge in the recycle cartridge receiver. At block 706, the method includes receiving excess material from the printing of the 3D object into the recycle material cartridge in the recycle cartridge receiver. For example, one or more integrated conveying systems of the printer may transport excess material from a build enclosure of the printer to the recycle material cartridge.

The 3D object may be printed from feed material composed of new material and recycle material. The feed material may have a specified weight or volume ratio of new material to recycle material in a range from zero to one. For example, the ratio as a weight ratio or volume ratio may range from 0.01 to 0.99, 0.05 to 0.95, 0.1 to 0.9, 0.15 to 0.85, 0.2 to 0.8, 0.25 to 0.75, 0.3 to 0.7, etc. The new material may be provided by a new material cartridge in a new cartridge receiver of the 3D printer. Alternatively, a new material vessel may provide the new material. The new material vessel may be disposed below the new cartridge receiver and supplied by the new material cartridge.

In 3D printers having a new material vessel and a recycle material vessel, the new material and the recycle material may be conveyed from the new material vessel and the recycle material vessel, respectively, to a thermal fusion system or build platform for printing of a 3D object. The new material and the recycle material may mix in-line and be conveyed to the thermal fusion system or thermal fusion module as feed material having the specified ratio of new material to recycle material. Instead of being fed directly to the build platform, the feed material may be conveyed through a dispense vessel to a build-material applicator which may apply the feed material across the build platform. Thus, the dispense vessel may supply feed material for the build platform.

While the present techniques may be susceptible to various modifications and alternative forms, the examples discussed above have been shown by way of example. It is to be understood that the techniques are not intended to be limited to the particular examples disclosed herein. Indeed, the present techniques include all alternatives, modifications, and equivalents falling within the scope of the present techniques.

What is claimed is:

1. A three-dimensional (3D) printer comprising:
a thermal fusion system to selectively fuse portions of successive layers of build material on a build platform for the 3D printer to generate a 3D object; and
a cartridge receiver to hold a removable material cartridge to accept build material into the removable material cartridge from the 3D printer and to make available build material from the removable material cartridge for generating the 3D object.

2. The 3D printer of claim 1, wherein the thermal fusion system comprises:
a printbar to eject a fusing agent onto build material to selectively fuse the portions of successive layers of build material on the build platform;
a movement device to position the printbar over the build platform; and
an energy source to apply energy to the fusing agent ejected onto the build material to selectively fuse the portions of successive layers of build material on the build platform.

3. The 3D printer of claim 1, comprising:
an internal vessel to receive the build material made available by the removable material cartridge; and
a powder spreader to disperse build material across a surface of the build platform.

4. The 3D printer of claim 1, comprising:
the build platform;
a build enclosure associated with the build platform, wherein the removable material cartridge to accept excess build material recovered from the build enclosure;
a build unit processing module to cool and manage cooling of the 3D object, and separate the 3D object from the excess build material; and
a 3D printed object recovery zone to recover the printed 3D object separated from the excess build material.

5. The 3D printer of claim 1, wherein the removable material cartridge comprises a housing to hold build material, wherein the cartridge receiver comprises a cavity, receptacle, slot, or sleeve, or any combination thereof, wherein the printer is to print the 3D object from the build material, and wherein the build material comprises powder comprising plastic, polymer, metal, glass, ceramic, or any combination thereof.

6. The 3D printer of claim 1, wherein the cartridge receiver comprises a recycle cartridge receiver, wherein the removable material cartridge comprises a recycle material cartridge to make available recycle material as build material for the build platform, or wherein the recycle material cartridge to receive recycle material from the 3D printer, and wherein the 3D printer comprises a new cartridge receiver to hold a new material cartridge to make available new material as build material for the build platform.

7. The 3D printer of claim 6, comprising:
a new material vessel to receive new material from the new material cartridge in the new cartridge receiver; and
a recycle material vessel to receive recycle material from the recycle material cartridge in the recycle cartridge receiver, wherein the recycle material cartridge to be removed from the recycle cartridge receiver to remove recycle material from the 3D printer.

8. The 3D printer of claim 7, comprising:
a dispense vessel to receive new material from the new material vessel and to receive recycle material from the recycle material vessel, and to supply the new material and the recycle material to the thermal fusion system for the build platform, wherein the 3D printer comprises a build enclosure associated with the build platform; and
a pneumatic conveyance system to convey the new material from the new material vessel to the dispense vessel and to convey the recycle material from the recycle material vessel to the dispense vessel.

9. A three-dimensional (3D) printer for thermal fusion printing, comprising:
a printbar to eject fusing agent onto build material on a build platform;
an energy source to apply energy to the fusing agent ejected onto the build material;
a new cartridge receiver to hold a new material cartridge to make available new material from the new material cartridge as build material; and
a recycle cartridge receiver to hold a recycle material cartridge to accept excess build material into the recycle material cartridge from the 3D printer and to make available recycle material from the recycle material cartridge as build material.

10. The 3D printer of claim 9, comprising:
the build platform to receive the build material;
a build enclosure associated with the build platform;
a dispense vessel to make available build material comprising the new material and the recycle material for the build enclosure;
a powder spreader to disperse build material across a surface of the build platform; and
a carriage to position the printbar over the build material on the build platform;

11. The 3D printer of claim 9, comprising:
a thermal fusion module to provide build material to the build platform;
a new material vessel to receive new material from the new material cartridge in the new cartridge receiver;
a recycle material vessel to receive recycle material from the recycle material cartridge in the recycle cartridge receiver;
a conveying system to provide build material to the thermal fusion module, the build material comprising new material from the new material vessel and recycle material from the recycle material vessel; and
a control system to facilitate the build material to the thermal fusion module to comprise a specified ratio of new material to recycle material.

12. A method of operating a three-dimensional (3D) printer, comprising:
printing, via thermal fusion, a 3D object from feed material comprising recycle material;
providing the recycle material from a recycle material cartridge in the 3D printer; and
receiving excess material into the recycle material cartridge in the 3D printer from the printing of the 3D object.

13. The method of claim 12, wherein printing, via thermal fusion, comprises:
spreading the feed material across a build platform;
ejecting a fusing agent onto the feed material on the build platform; and
applying energy to the fusing agent ejected onto the feed material on the build platform.

14. The method of claim 12, wherein the feed material comprises new material, wherein the method further comprises providing the new material from a new material cartridge in the 3D printer, and wherein the feed material comprises a specified ratio of new material to recycle material.

15. The method of claim 14, wherein providing the new material comprises receiving the new material into a new material vessel from the new material cartridge, wherein providing the recycle material comprises receiving the recycle material into a recycle material vessel from the recycle material cartridge, wherein the method further comprises conveying the new material and the recycle material from the new material vessel and the recycle material vessel, respectively, at the specified ratio to a build enclosure for printing the 3D object, and wherein the new material and the recycle material mix in-line to the build enclosure as the feed material.
